(19) United States
(12) Patent Application Publication
(10) Pub. No.: US 2007/0024122 A1
(43) Pub. Date: Feb. 1, 2007

(54) System and method for a distributed front end rectifier power system

(76) Inventors: Steve Belson, Plano, TX (US); Shaun Harris, McKinney, TX (US); Robert Guenther, Pepperell, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/193,266

(22) Filed: Jul. 27, 2005

(51) Int. Cl. H02J 1/10

(52) U.S. Cl. 307/43

(57) ABSTRACT

Embodiments of a distributed front-end rectifier system in an electronics system and related methods are disclosed. One system embodiment comprises a first alternating current-to direct current (AC/DC) front end rectifier, a second AC/DC front end rectifier, and an AC power bus directly connected to the first AC/DC front end rectifier and the second AC/DC front end rectifier.

### BACKGROUND

Centralized electronic systems, such as a communication network system or a parallel computer processing system, employ a variety of electronic devices residing in a housing or other suitable enclosure. One type of electronic device included in such systems is the front end rectifier.

The front end rectifier converts alternating current (AC) power into an intermediate direct current (DC) power/current/voltage. Power is received from the AC distribution system, which may be, for example, provided at 120 volts AC or 240 volts AC. Electronic rectifying devices convert the received AC power (AC current and AC voltage) into DC power (DC current and DC voltage). Intermediate DC voltage may be, for example, at 48 volts or 12 volts DC, though any suitable intermediate DC voltage may be used depending upon the system design.

Intermediate DC power/current/voltage is used to provide power to individual devices in the electronic system. However, the electronic devices typically require a different DC voltage for operation, so further DC/DC voltage transformation is required. The total amount of DC current required by the electronic system is determined, in part, by the loading requirements of the other devices in the system.

FIG. 1 is a simplified block diagram illustrating a conventional front end rectifier 102. Within the front end rectifier 102 is the alternating current to direct current (AC/DC) rectifier 104 and the direct current to direct current (DC/DC) voltage conversion unit 106.

The AC/DC rectifier 104 receives AC power/current/voltage, via connection 108. Connection 108 is illustrated as a single line for convenience, and may be a plurality of wire connections depending upon the nature of the AC power source. The received AC power is converted to DC and output at a voltage that corresponds to the voltage of the AC power source, referred to as the rectified DC voltage. The rectified DC voltage is provided to the DC/DC voltage conversion unit 106, via connection 110.

The DC/DC voltage conversion unit 106 converts the received rectified DC voltage into an intermediate DC voltage. The intermediate DC voltage is provided to the intermediate DC voltage bus 112, via connection 114.

DC power, at the intermediate DC voltage, is then provided to a plurality of DC/DC converter output modules 116a-i, via connections 118a-i. The DC/DC converter output modules 116a-i convert the received intermediate DC voltage into the load DC voltage required by the loads 120a-i, via connections 122a-122i. The loads 120a-i correspond to one or more of the electronic devices residing in the electronic system.

An exemplary power supply system is illustrated and described in U.S. patent application Ser. No. 09/753,056 to Brooks et al., published as publication 2002/0085399, which is incorporated by reference herein in its entirety. Accordingly, individual components of the front end rectifier 102, the AC/DC rectifier 104, the DC/DC voltage conversion unit 106, the DC/DC converter output modules 116a-i and the loads 120a-i are not described in detail herein. Furthermore, various other configurations of front end rectifiers are known that provide the same or similar functionality.

As a simplified illustrative example, assume that the front end rectifier 102 receives three phase, 120 volt AC power. The AC/DC rectifier 104 converts the received 120 volt AC power into a rectified DC voltage that corresponds to 120 volts. Then, the DC/DC voltage conversion unit 106 converts the rectified DC voltage to the intermediate DC voltage, which may be, for example, 48 volts. The DC/DC converter output modules 116a-i receive the intermediate DC voltage, via the intermediate DC voltage bus 112, and convert the received DC voltage to the voltage used by loads 120a-i. Examples of load voltages may be 12.5 volts DC, 5 volts DC or 3.5 volts DC, as illustrated in Brooks et al.

Conventional electronic systems employ a single intermediate DC voltage bus 112. The intermediate DC power is distributed to the DC/DC converter output modules 116a-i over the above described intermediate DC voltage bus 112. The “capacity” of the intermediate DC voltage bus 112 is determined, in part, by the total load drawn by the electronic devices residing in the enclosure. “Capacity” is the total amount of power that can be converted and/or transmitted by a device or component. Thus, the intermediate DC voltage bus 112 will likely be a large gauge wire or bus bar that is sized to have sufficient capacity to safely transmit the total DC current load drawn by the electronic devices residing in the enclosure.

Another factor that determines the “size” of the intermediate DC voltage bus 112 is the size of the enclosure, the location of the DC/DC converter output modules 116a-i in the enclosure, and the physical distance of the terminals of the front end rectifier 102 to the DC/DC converter output modules 116a-i. Accordingly, the intermediate DC voltage bus 112 residing in the enclosure must be sufficiently sized to accommodate the total DC current load requirements, and must be physically large enough to reach the various DC/DC converter output modules 116a-i.

When the centralized electronic system has a large number of electronic devices residing in the enclosure and/or or has electronic devices which draw a large amount of DC current, the physical size of the intermediate DC voltage bus 112 may be relatively large. A large intermediate DC voltage bus 112 inherently has several disadvantages.

First, a relatively large intermediate DC voltage bus 112 is expensive because it must be sized in accordance with the ultimate loading requirements of the devices that will ultimately reside within the enclosure. Second, a relatively large intermediate DC voltage bus 112 may take up a large portion of the useable space in the enclosure. Third, a relatively large intermediate DC voltage bus 112 which is sized to accommodate a large DC current incurs relatively high resistive losses.

High resistive losses manifest in various undesirable ways. High DC resistive losses constitute an energy cost since the resistive losses consume power. Also, high DC resistive losses result in generated heat, which may be a limiting factor in the design of the enclosure. Excessive heating within the enclosure may degrade performance of the electrical devices in the enclosure, may degrade the useful operating life of the electrical devices in the enclosure, and/or may constitute a possible fire hazard. Finally, heat generated by the various components of the electric system, including the intermediate DC voltage bus 112, is a factor that falls under the purview of the National Electric Safety Code in that maximum temperature limitations of an electric system and its components are regulated. If the temperature within the enclosure exceeds regulated limitations, then various mitigating measures must be taken. For example, auxiliary cooling devices such as fans or coolers may be employed, or the number of electric devices may be limited. Also, more space between electric devices may be required, thereby increasing the size of the enclosure.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating a conventional front end rectifier.

FIG. 2 is a block diagram illustrating an exemplary distributed front end rectifier system.

FIG. 3 is an illustrative block diagram of an alternative embodiment of the distributed front end rectifier system employing a plurality of relatively smaller intermediate DC voltage buses coupled to one or more of the individual DC/DC converter output modules.

FIG. 4 is an illustrative block diagram of an alternative embodiment of the distributed front end rectifier system providing redundancy with two separate AC power buses, and with two distributed front end rectifiers.

FIG. 5 is an illustrative block diagram of components residing in an embodiment of the distributed front end rectifier system.

FIG. 6 is a flowchart illustrating a process used by an embodiment of a distributed front end rectifier system.

FIG. 7 is a flowchart illustrating a process used by an embodiment of a distributed front end rectifier system.

### DETAILED DESCRIPTION

FIG. 2 is a block diagram illustrating an exemplary distributed front end rectifier system 200. The distributed front end rectifier system 200 comprises at least two distributed front end rectifiers (202a, 202b) and, more generally, distributed front end rectifiers 202a-202i and a plurality of distributed intermediate DC voltage busses 204a-204i (or generally referred to as distributed intermediate DC voltage busses 204).

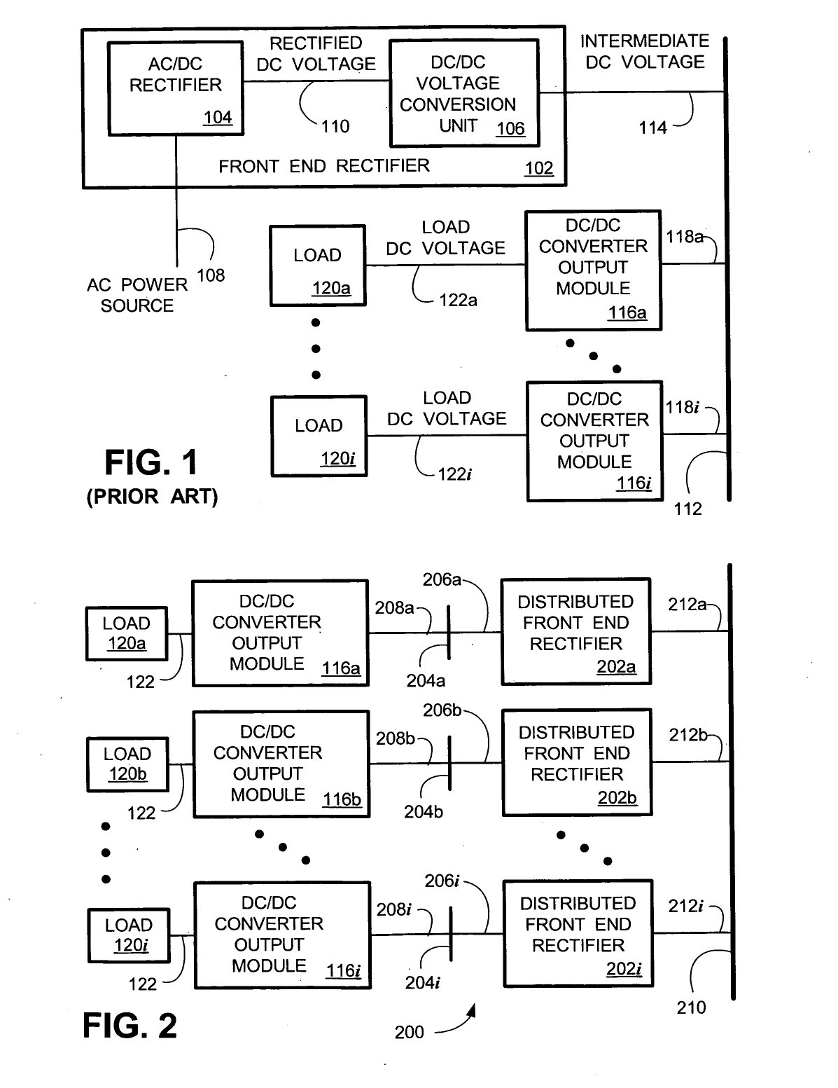

In this exemplary embodiment, one of the distributed front end rectifiers 202a-202i sources (provides) DC power/voltage/current to one of the distributed intermediate DC voltage busses 204 that it is coupled to, via one of connections 206a-206i (or generally, 206). Each of the distributed intermediate DC voltage busses 204 are coupled to one or more of the above-described DC/DC converter output modules 116a-i, via connections 208a-208i (or generally, 208). Accordingly, in this exemplary embodiment, the single intermediate DC voltage bus 112 (FIG. 1) is not present. As noted above, the DC/DC converter output modules 116a-i provide DC power/voltage/current to the above-described loads 120a-i.

Here, each of the distributed intermediate DC voltage busses 204 may be configured similar to the intermediate DC voltage bus 112, but is relatively smaller in size and, accordingly, may be more conveniently located (distributed) within the enclosure relatively close to the DC/DC converter output modules 116a-i to which it is coupled to, via connections 208. Furthermore, each of the distributed intermediate DC voltage busses 204 will likely be a relatively smaller gauge wire or relatively smaller bus bar (relative to the conventional intermediate DC voltage bus 112 of FIG. 1). Each of the distributed intermediate DC voltage busses 204 need only be sized to safely transmit DC current corresponding to the total load drawn by the electronic devices to which it is coupled to. Thus, a plurality of distributed intermediate DC voltage busses 204 would be employed in the enclosure.

Embodiments of the distributed front end rectifier system 200 employ at least one AC power bus 210. AC power bus 210 provides AC power/current/voltage. Accordingly, AC power bus 220 may be smaller and less expensive than the relatively large intermediate DC voltage bus 112. Resistive losses may also be relatively less than the losses on a conventional relatively large intermediate DC voltage bus 112. Furthermore, if the AC power bus 210 is external to the enclosure, heat generated by resistive losses will occur outside of the enclosure, thereby facilitating a more compact construction or assembly of the electronic system in which embodiments of the distributed front end rectifier system 200 are employed.

In the various embodiments, the AC power bus 210 is coupled to the distributed front end rectifiers 202a-202i, via connections 212a-212i (or generally, 212). Each of the connections 212 are illustrated as a single connection for convenience. In various embodiments, connections 212 may be a plurality of wire connections depending upon the nature of the AC power source (for example, if AC power is provided as single-phase power, two-phase power or three-phase power). Alternatively, one or more of connections 212 may be implemented as a coupling device configured to couple to a corresponding device on an AC power system. For example, but not limited to, connection 212 may be a 120 volt AC plug configured to receive AC power from a suitable conventional power cord. As another non-limiting example, the AC connection 212 may be itself a power cord configured to plug into a receptacle system, such as a power supply receptacle bar or the like, which is an external AC power bus 210. It is appreciated that any type of AC power supply connectivity system may be used by various embodiments of the distributed front end rectifier system 200.

Power may be received from an AC distribution system, which may be, for example, at 120 volts AC or 240 volts AC. AC power may be single-phase, two-phase or three-phase power. Frequency of the AC power may be any suitable frequency, such as, but not limited to, the 60 hertz used in the United States, or the 50 hertz used in other countries.

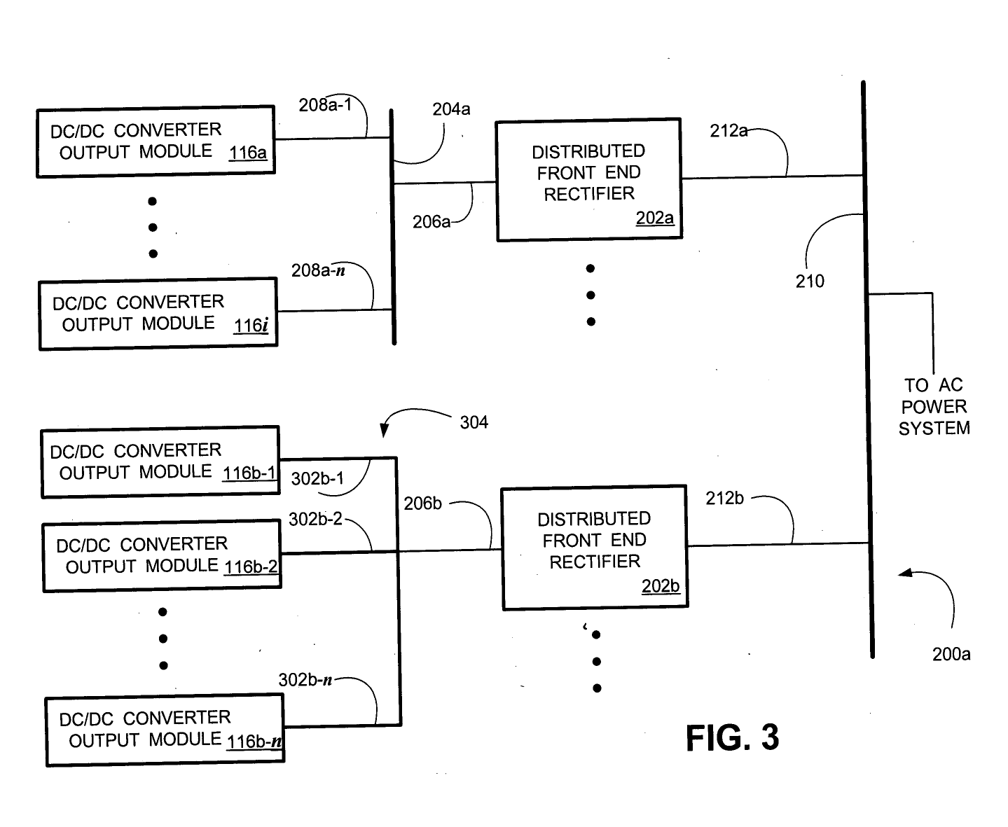

FIG. 3 is an illustrative block diagram of an embodiment of the distributed front end rectifier system 200a sourcing one of the relatively smaller intermediate DC voltage buses 204 coupled to a plurality of individual DC/DC converter output modules 116a-i, via connections 208.

For convenience, a single distributed intermediate DC voltage bus 204a is illustrated coupled between the distributed front end rectifier 202a and the DC/DC converter output modules I 116a-1 through 116a-n. It is appreciated that the single distributed intermediate DC voltage bus 204a could be coupled to any number of relatively close-by DC/DC converter output modules and/or to more than one distributed front end rectifier depending upon the system design.

In one embodiment, the distributed front end rectifiers are coupled to one or more flexible power cord devices 302b-1 through 302b-n (or generally, 302), and/or a power harness type device 304, that is coupled to one or more of the individual DC/DC converter output modules 116b-1 through 116b-n). Here, the flexible power cord devices 302, and/or a power harness type device 304, are alternative embodiments of a distributed intermediate DC voltage bus.

For convenience, the flexible power cord devices 302, and/or a power harness type device 304, are illustrated coupled between the distributed front end rectifier 202b and the converter output modules 116b-1 through 116b-n. It is appreciated that the flexible power cord devices 302, and/or a power harness type device 304, could be coupled to any number of relatively close-by DC/DC converter output modules and/or to more than one distributed front end rectifier depending upon the system design.

A plurality of relatively smaller distributed intermediate DC voltage busses 204, power cord devices 302, and/or a power harness type devices 304 may have a relatively lower cost since they could be designed with a smaller capacity that corresponds to the relatively near-by loads to which they source (provide power to). Also, relatively smaller distributed intermediate DC voltage busses 204 will provide for convenient installation since they are smaller, and therefore easier to manipulate and place into position by the person performing the installation, thereby having a relatively less expensive installation cost.

As additional loads are added into the enclosure, additional distributed intermediate DC voltage busses 204, power cord devices 302, and/or power harness type devices 304 may be installed as load within the enclosure increases. That is, the intermediate power distribution system 200 (e.g., 200a) need not be initially sized for the ultimate load anticipated for the enclosure. Since lower resistive losses correlate to less heat generated within the enclosure, a more compact installation of electronic devices within the enclosure is permitted.

Also, placement of electronic devices within the enclosure will not be as limited since relatively smaller distributed intermediate DC voltage busses 204, power cord devices 302, and/or power harness type devices 304 may be located closer to individual loads 120a-i. In a conventional enclosure, the individual DC/DC converter output modules 116a-i are placed in close proximity to the relatively large intermediate DC voltage bus 112. In the various embodiments of the distributed front end rectifier system 200, the relatively smaller distributed intermediate DC voltage busses 204, power cord devices 302, and/or power harness type devices 304 may be installed at more desirable locations within the enclosure which are closer to the individual DC/DC converter output modules 116a-i to which they are coupled to.

Furthermore, placing the distributed intermediate DC voltage busses 204, power cord devices 302, and/or a power harness type devices 304 closer to the loads will reduce resistive losses since there is relatively less distance to the individual DC/DC converter output modules 116a-i to which they are coupled to (less physical distance corresponds to a lower resistance of each of the distributed intermediate DC voltage busses 204, power cord devices 302, and/or a power harness type devices 304), and thereby will be more economical since less power will be consumed.

Reliability of the electronic system may be enhanced by other embodiments of the distributed front end rectifier system 200. Upon loss of one of the components of a conventional power system, failure of the electronic devices which are supplied power will occur since power is no longer available. For example, a contingency event may occur remotely on the AC power supply system. In the event of the loss of the AC power supply system, power to the entire electronic system will occur.

As another example, a failure of the AC power bus 210, such as might be caused by a ground fault during insulation failure, will cause loss of power to components coupled to the AC power bus 210. Similarly, failure of one of the distributed front end rectifiers 202a-i, failure of one of the DC/DC converter output modules 116a-i, and/or failure of one of the distributed intermediate DC voltage busses 204, power cord devices 302, and/or power harness type devices 304, will cause loss of power to those devices that receive power from the failed device. For example, a component residing in one of the distributed front end rectifiers 202a-i or one of the DC/DC converter output modules 116a-i might fail, thereby causing failure of the entire above-described device.

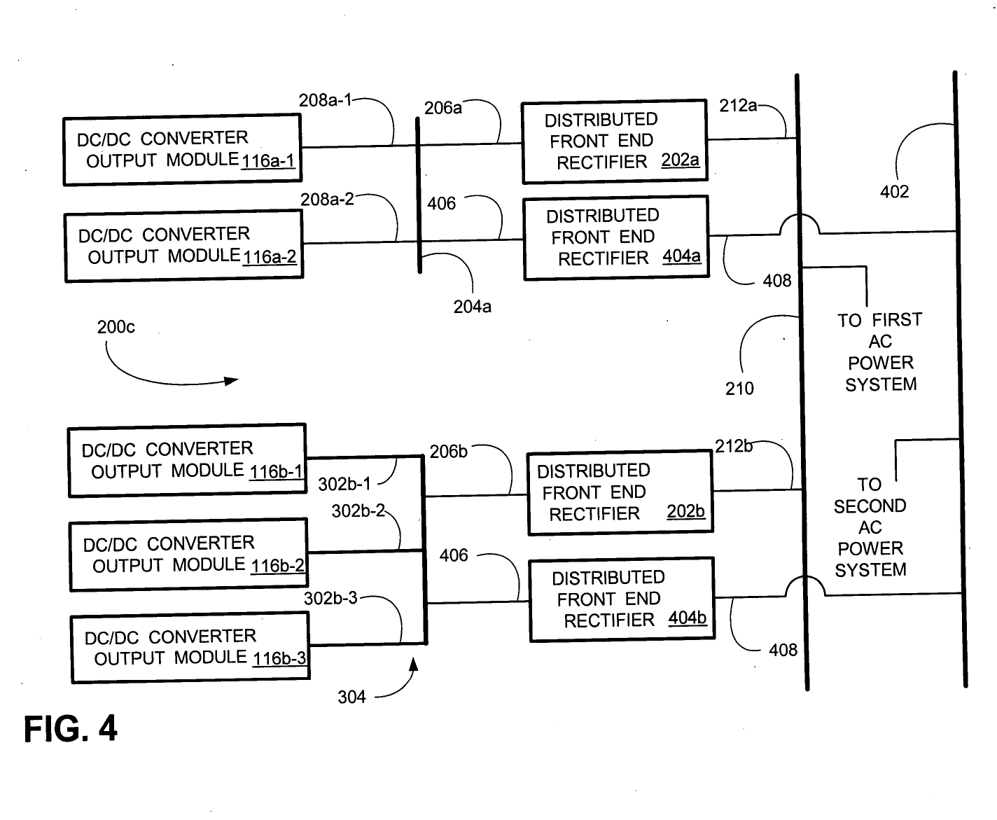

Embodiments of the distributed front end rectifier system 200 may overcome such contingencies by providing component redundancy. FIG. 4 is an illustrative block diagram of an alternative embodiment of the distributed front end rectifier system 200c providing redundancy with two separate AC power buses 210 and 402, and with two distributed front end rectifiers 202a and 404a. For example, power is supplied to the DC/DC converter output modules 116a-1 and 116a-2 via the distributed intermediate DC voltage bus 204a, the distributed front end rectifier 202a and the first AC power bus 210. A separate distributed power system supplies power to the DC/DC converter output modules 116a-1 and 116a-2 via the distributed intermediate DC voltage bus 204a, connection 406, the distributed front end rectifier 404a, connection 408 and the second AC power bus 402.

In the event of a single contingency loss of the distributed front end rectifier 202a and/or the first AC power bus 210 (or one of the components residing therein), power will still be supplied to the distributed intermediate DC voltage bus 204a via the distributed front end rectifier 404a and the second AC power bus 402. Similarly, in event of a single contingency loss of the distributed front end rectifier 404a and/or the second AC power bus 402 (or one of the components residing therein), power will still be supplied to the distributed intermediate DC voltage bus 204a via the distributed front end rectifier 202a and the first AC power bus 210.

For embodiments of the distributed front end rectifier system 200 that employ power cord devices 302 and/or power harness type devices 304, a similar redundant power system may be employed. A separate distributed power system supplies power to the DC/DC converter output modules 116b-1, 116b-2 through 116b-3 via the power cord devices 302 and/or a power harness type devices 304, connection 406, the distributed front end rectifier 404b, connection 408 and the second AC power bus 402.

In embodiments of the distributed front end rectifier system 200, the same or different intermediate voltages may be used. For example, but not limited to, the intermediate voltage on the distributed intermediate DC voltage busses 204 may be different from intermediate voltage on the power cord devices 302 and/or power harness type devices 304 (FIG. 3).

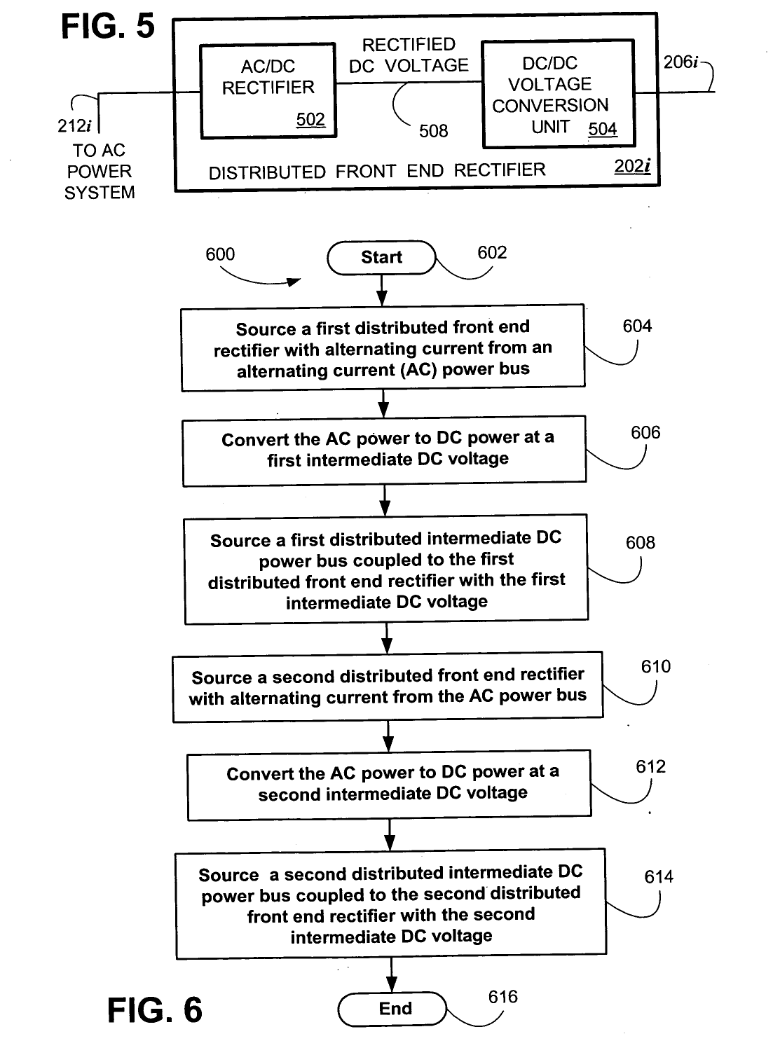

FIG. 5 is an illustrative block diagram of components residing in an embodiment of the distributed front end rectifier system. Within the distributed front end rectifier 202i is the AC/DC rectifier 502 and the DC/DC voltage conversion unit 504.

The AC/DC rectifier 502 receives AC power/current/voltage, via connection 212i. Connection 212i is illustrated as a single line for convenience, and may be a plurality of wire connections depending upon the nature of the AC power source. The received AC power is converted to DC and output at a voltage that corresponds to the voltage of the AC power source, referred to as the rectified DC voltage. The rectified DC voltage is provided to the DC/DC voltage conversion unit 504, via connection 508.

The DC/DC voltage conversion unit 504 converts the received rectified DC voltage into the above-described intermediate DC voltage. The intermediate DC voltage is output on connection 206i.

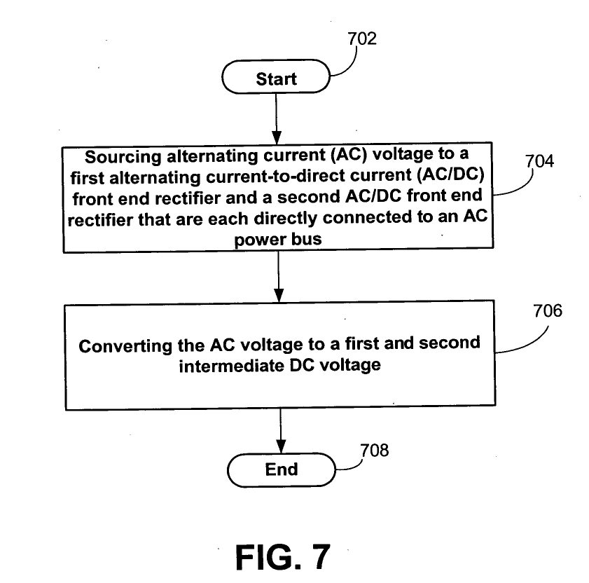

FIGS. 6 and 7 show flow charts 600 and 700, respectively, illustrating processes used by embodiments of a distributed front end rectifier system 200 (FIG. 2). It should be noted that in alternative embodiments, the functions noted in the blocks may occur out of the order noted in FIGS. 6 and 7, or may include additional functions. For example, two blocks shown in succession in FIGS. 6 and 7 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

One embodiment of a process, shown in FIG. 6, begins at block 602. At block 604, a first distributed front end rectifier is sourced with alternating current from an alternating current (AC) power bus. At block 606, the AC power is converted to DC power at a first intermediate DC voltage. At block 608, a first distributed intermediate DC voltage bus coupled to the first distributed front end rectifier is sourced with the first intermediate DC voltage. At block 610, a second distributed front end rectifier is sourced with alternating current from the AC power bus. At block 612, the AC power is converted to DC power at a second intermediate DC voltage. At block 614, a second distributed intermediate DC voltage bus coupled to the second distributed front end rectifier is sourced with the second intermediate DC voltage. The process ends at block 616.

Another embodiment, shown in FIG. 7, begins at 702. Block 704 comprises sourcing alternating current (AC) voltage to a first alternating current-to-direct current (AC/DC) front end rectifier and a second AC/DC front end rectifier that are each connected to an AC power bus. Block 706 comprises converting the AC voltage to a first and second intermediate DC voltage. The process ends at block 708.

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. A distributed front-end rectifier system in an electronics system, comprising:
a first alternating current-to direct current (AC/DC) front end rectifier;
a second AC/DC front end rectifier; and
an AC power bus directly connected to the first AC/DC front end rectifier and the second AC/DC front end rectifier.

2. The system of claim 1, wherein the first and the second AC/DC front end rectifiers each comprise at least an AC/DC rectifier and a DC/DC voltage conversion unit.

3. The system of claim 1, further comprising a first intermediate DC voltage bus coupled to the first AC/DC front end rectifier and at least one DC/DC converter output module.

4. The system of claim 3, further comprising a second intermediate DC voltage bus coupled to the second AC/DC front end rectifier and at least one DC/DC converter output module.

5. The system of claim 4, wherein the AC power bus resides in an enclosure with the first and the second AC/DC front end rectifiers and the first and the second intermediate DC voltage busses.

6. The system of claim 4, wherein the AC power bus resides outside of an enclosure where the first and the second AC/DC front end rectifiers and the first and the second intermediate DC voltage busses reside.

7. The system of claim 4, wherein the first intermediate DC voltage bus comprises a bus bar type device, a connector, a power cord device, or a power harness type device.

8. The system of claim 4, wherein the second intermediate DC voltage bus comprises a bus bar type device, a connector, a power cord device, or a power harness type device.

9. The system of claim 4, further comprising a redundant AC power bus and a third AC/DC front end rectifier, wherein the third AC/DC front end rectifier is coupled between the redundant AC power bus and the first intermediate DC voltage bus.

10. The system of claim 9, further comprising a fourth AC/DC front end rectifier, wherein the fourth AC/DC front end rectifier is coupled between the redundant AC power bus and the second intermediate DC voltage bus.

11. The system of claim 1, wherein the first AC/DC front end rectifier converts received AC power to DC power at a first intermediate DC voltage, and wherein the second AC/DC front end rectifier converts received AC power to DC power at a second intermediate DC voltage.

12. A method of distributing direct current (DC) power to electronic loads, the method comprising:
sourcing alternating current (AC) voltage to a first alternating current-to-direct current (AC/DC) front end rectifier and a second AC/DC front end rectifier that are each directly connected to an AC power bus; and
converting the AC voltage to a first and second intermediate DC voltage.

13. The method of claim 12, wherein converting comprises converting the AC voltage to the first and the second intermediate DC voltages that are equal in value.

14. The method of claim 12, wherein converting comprises converting the AC voltage to the first and the second intermediate DC voltages that are unequal in value.

15. The method of claim 12, wherein converting comprises converting the AC voltage to a rectified DC voltage and converting the rectified DC voltage to the first and second intermediate voltage.

16. The method of claim 12, further comprising sourcing the first intermediate voltage to a first intermediate DC voltage bus coupled to the first AC/DC front end rectifier and at least one DC/DC converter output module.

17. The method of claim 16, further comprising sourcing a second AC voltage to a third AC/DC front end rectifier, wherein the third AC/DC front end rectifier is coupled to the first intermediate DC voltage bus.

18. The method of claim 12, further comprising sourcing the second intermediate voltage to a second intermediate DC voltage bus coupled to the second AC/DC front end rectifier and at least one DC/DC converter output module.

19. The method of claim 18, further comprising sourcing the second AC voltage to a fourth AC/DC front end rectifier, wherein the fourth AC/DC front end rectifier is coupled to the second intermediate DC voltage bus.

20. A distributed front-end rectifier system in an electronics system, comprising:
means for sourcing alternating current (AC) voltage to a first alternating current-to-direct current (AC/DC) front end rectifier and a second AC/DC front end rectifier that are each directly connected to an AC power bus; and
means for converting the AC voltage to a first and second intermediate DC voltage.

21. The system of claim 20, further comprising means for sourcing the first intermediate voltage to a first intermediate DC voltage bus coupled to the first AC/DC front end rectifier and at least one DC/DC converter output module.

22. The system of claim 21, further comprising means for sourcing a second AC voltage to a third AC/DC front end rectifier, wherein the third AC/DC front end rectifier is coupled to the first intermediate DC voltage bus.

23. The system of claim 20, further comprising means for sourcing the second intermediate voltage to a second intermediate DC voltage bus coupled to the second AC/DC front end rectifier and at least one DC/DC converter output module.

24. The system of claim 20, further comprising means for sourcing the second AC voltage to a fourth AC/DC front end rectifier, wherein the fourth AC/DC front end rectifier is coupled to the second intermediate DC voltage bus.
